(19) United States
(12) Patent Application Publication
(10) Pub. No.: US 2005/0099885 A1
(43) Pub. Date: May 12, 2005

(54) Drive mechanism for a rear engine power takeoff

(76) Inventor: Jacob R. Tamminga, Orton (CA)

Correspondence Address: VALENTINE A. COTTRILL, SUITE 1020 50 QUEEN STREET NORTH, KITCHENER, ON, N2H6M2, CA

(21) Appl. No.: 10/704,572

(22) Filed: Nov. 12, 2003

(51) Int. Cl. B01F 7/00

(52) U.S. Cl. 366/314

(57) ABSTRACT

A drive mechanism for use with an engine in combination with a rear engine power takeoff operatively connected to the engine before a transmission. The drive mechanism has a first shaft rotatably connected between the rear engine power takeoff and an activator for the drive mechanism and an adjustment gearbox operatively connected to the activator. The adjustment gearbox is rotatably connected to a second shaft extending to a driven gearbox. The second shaft is adapted for rotation up to a predetermined speed. The activator is adapted to activate the adjustment gearbox, thereby operatively connecting the first shaft to the adjustment gearbox, and to de-activate the adjustment gearbox. Also, the adjustment gearbox is adapted for adjustment of the speed of rotation of the first shaft so that the speed of rotation of the second shaft is within the predetermined speed.

### BACKGROUND OF THE INVENTION

1. Field of the Invention

This invention relates to a drive mechanism that is connected between a rear engine power takeoff of a truck engine and equipment mounted on a truck bed of the truck. More particularly, this invention relates to a drive mechanism and rear engine power takeoff in combination and a method of constructing a drive mechanism between a rear engine power takeoff of a truck and equipment mounted on the truck bed.

2. Description of the Prior Art

Rear engine power takeoff assemblies are known. The rear engine power takeoff is connected between the truck engine and the truck transmission. A live connection exists and the rear engine power takeoff (REPTO) operates whenever the truck engine is operating. Since the REPTO is connected between the engine and the transmission, the power output of the REPTO is much higher than it would be if a PTO was connected after the transmission of the truck engine. A PTO connected after the transmission has a maximum horsepower of approximately one hundred. Where required horsepower exceeds one hundred, connection to a PTO after the transmission is no longer suitable.

It is known to connect hydraulic pumps and hydraulic motors to the REPTO of a truck engine to drive equipment on the truck bed or to drive equipment mounted elsewhere on the truck or remote from the truck using hydraulic power obtained from the hydraulic pump or motor. For example, on concrete trucks, it is known to use a hydraulic pump connected to a REPTO to pump concrete from the truck bed to a desired location. Similarly, it is known to drive a vertical mixer mounted on a truck bed using a hydraulic motor connected to the REPTO. An hydraulic pump or motor is very expensive and very complex. Hydraulic pumps or motors can be difficult and expensive to service and maintain.

### SUMMARY OF THE INVENTION

It is an object of the present invention to provide a drive mechanism that is connected to the REPTO of a truck engine to drive equipment mounted on a truck bed of the truck by way of a mechanical connection that can be converted to the RPM desired for driving the equipment and can be engaged or disengaged, as desired.

A drive mechanism is used with a rear engine power takeoff of an engine of a truck. The truck has a cab and a truck bed extending to the rear of the cab. The rear engine power takeoff extends toward the truck bed and rotates when the engine operates. The combination comprises an activator and an adjustment gear box, the activator having clutch plates. The activator and the adjustment gear box are interconnected and are connected between the rear engine power take off and equipment supported on the truck bed. The activator has an engaged position and a disengaged position. The activator is movable between the engaged position and the disengaged position while the engine is operating.

A drive mechanism and a rear engine power takeoff of an engine of a truck in combination has a truck with a cab and a truck bed extending to a rear of the cab. The rear engine power takeoff extends toward the truck bed and rotates when the engine operates. The combination comprises the drive mechanism and the power takeoff. The drive mechanism has a first shaft rotatably connected between the power takeoff and an activator for the drive mechanism. The activator has clutch plates. The activator has an engaged position and a disengaged position, the activator being connected to an adjustment gearbox. The adjustment box is connected to a second shaft, the second shaft being rotatably connected directly or indirectly to equipment supported on the truck bed. The drive mechanism drives the equipment when the activator is in the engaged position through rotation of the second shaft. The adjustment box adjusts the RPM of the second shaft relative to the first shaft. The activator is movable between the engaged position and the disengaged position while the engine is operating.

A drive mechanism is used with a rear engine power takeoff of an engine of a truck. The truck has a cab and a truck bed extending to the rear of the cab. The rear engine power takeoff extends toward the truck bed and rotates when the engine operates. The drive mechanism comprises an activator and an adjustment gearbox, the activator having clutch plates. The activator and the adjustment gearbox are interconnected and are connected between the rear engine power takeoff and equipment supported on the truck bed. The activator has an engaged position and a disengaged position. The activator is movable between the engaged position and the disengaged position while the engine is operating.

A drive mechanism is used with a rear engine power takeoff of an engine of a truck, the truck having a cab and a truck bed extending to a rear of the cab. The rear engine power takeoff extends toward the truck bed and rotates when the engine operates. The drive mechanism comprises a first shaft rotatably connected between the rear power takeoff and an activator for the drive mechanism. The activator has clutch plates and has an engaged position and a disengaged position. The activator is connected to an adjustment gearbox, the adjustment gearbox being connected to a second shaft. The second shaft is rotatably connected directly or indirectly to equipment supported on the truck bed. The drive mechanism drives the equipment when the activator is in the engaged position through rotation of the second shaft. The adjustment gearbox adjusts an RPM of the second shaft to the first shaft. The activator is movable between the engaged position and the disengaged position while the engine is operating.

A method of constructing a mechanical drive mechanism on a rear engine power takeoff of an engine of a truck uses a truck having a cab and a truck bed extending to the rear of the cab. The rear engine power takeoff extends toward the truck bed and rotates when the engine operates. The drive mechanism has an activator with clutch plates and an adjustment box. The method comprises interconnecting the activator and the adjustment box, connecting the activator to the adjustment box, connecting the activator to the rear engine power takeoff and connecting the adjustment box to equipment supported on the truck bed.

A method of constructing a mechanical drive mechanism to a rear engine power takeoff of an engine of a truck, said truck having a cab and a truck bed extending to a rear of said cab, said rear engine power takeoff extending toward said truck bed and rotating when said engine operates, said drive mechanism having a first shaft, an activator having clutch plates, an adjustment gearbox and a second shaft, said method comprising rotatably connecting said first shaft between said power takeoff and said activator, connecting said activator to said adjustment gearbox, connecting said adjustment gearbox to a rotatable second shaft, said second shaft being rotatably connected directly or indirectly to equipment supported on said truck bed, said activator having an engaged position and a disengaged position, starting an engine of said truck with said activator in a disengaged position, operating said engine at an appropriate RPM, moving said activator from said disengaged position to said engaged position, thereby driving said equipment on said truck bed, subsequently moving said activator from said engaged position to said disengaged position to stop driving said equipment and turning off said engine.

### BRIEF DESCRIPTION OF THE DRAWINGS

FIG. 1, there is shown a schematic top view of a drive mechanism between a rear engine power takeoff and a vertical mixer.

### DESCRIPTION OF A PREFERRED EMBODIMENT

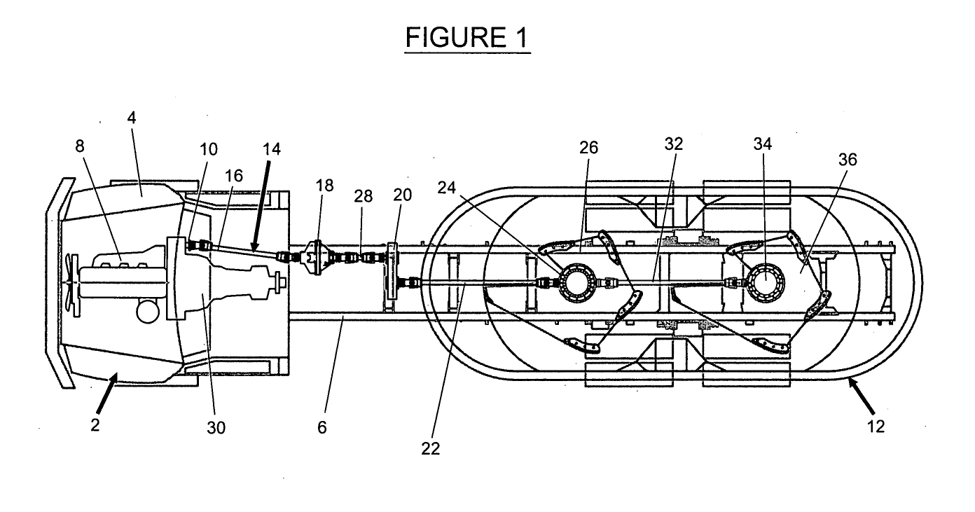

In FIG. 1, there is shown a truck 2 having a cab 4 with a truck bed 6 extending to a rear of said cab. The truck 2 has an engine 8, which operates the truck, the engine 8 having a rear engine power takeoff 10 extending from the engine 8 toward the truck bed 6. A vertical mixer 12 is mounted on the truck bed 6. A drive mechanism 14 extends between the rear engine power takeoff 10 and the vertical feed mixer 12. The drive mechanism 14 has a first shaft 16 rotatably connected between the rear engine power takeoff 10 and an activator 18. The activator 18 has clutch plates (not shown) and is connected to an adjustment gearbox 20. A second shaft 22 is rotatably connected between the adjustment gearbox 20 and a first mixer gearbox 24 connected to a first auger 26 of the vertical mixer 12. Preferably, the vertical mixer 12 is a vertical feed mixer. A third shaft 28 is rotatably connected between the activator 18 and the adjustment box 20.

The rear engine power takeoff 10 is connected to the engine 8 before a transmission 30. The activator 18 has an engaged position and a disengaged position. A fourth shaft 32 is rotatably connected between the first mixer gearbox 24 of the auger 26 and a second mixer gearbox 34 of a second auger 36. While the vertical mixer 12 is shown as having two augers 26,36, a vertical mixer could have a single auger only or could have more than two augers.

The activator 18 is preferably a clutch assembly. When the engine is operating, the rear engine power takeoff rotates. The clutch assembly has a clutch with clutch plates (now shown) that can be engaged to activate the drive mechanism 14 or disengage to deactivate the drive mechanism 14. In the engaged position, the augers will rotate and in the disengaged position, the augers will not rotate. Various other activators can be used, including a torque converter or a hydraulic fluid clutch to engage or disengage the drive mechanism. The clutch plates can be dry or wet. Preferably, the activator is operable from inside the cab 4, but could be connected to operate from outside the cab.

The adjustment gearbox 20 is preferably a reduction gearbox. The adjustment gearbox 20 can be designed to increase the RPM of the engine. The engine 8 operates at a high RPM (eg. 2600 RPM) and that RPM must be decreased to approximately 30-40 RPM to drive the augers of the vertical mixer. The reduction gearbox reduces the RPM coming from the engine 8 through the activator 18, through the third shaft 28 and through the reduction gear box to the second shaft 22. The first and second mixer gearboxes 24,34 that are connected to the augers 26,36 respectively, are not designed to convert the high RPM from the engine to the low RPM required by the augers. If the first mixer gearbox 24 were redesigned, it could be used to reduce the RPM from the engine and the mixer gearbox would then become the adjustment gearbox and the adjustment gearbox 20 could be eliminated. In other words, the adjustment gearbox 20 would be relocated to the location of the first gearbox 24 and the second shaft 22 could then be eliminated. In this embodiment, the second shaft would be the shaft extending between the adjustment box and the equipment being driven on the truck bed.

The rear engine power takeoff rotates at a higher or lower RPM based on the engine speed of the engine 8. The engine speed of the engine 8 can, of course, be controlled from within the cab. However, remote control could be set up to control the engine speed as well as the activator outside of the cab. In operation, with the activator in the disengaged position, the engine is turned on. The activator is then moved to the engaged position causing the augers to rotate. When the vertical mixer has been operated for a sufficient period of time, the activator is disengaged and the augers will stop rotating. The engine is then turned off, when desired.

Preferably, the reduction box is a spur gear reduction gearbox. The gearbox is conventional and houses two gears (not shown), an input gear and an output gear. The input gear is smaller in diameter as compared to the output gear to reduce the input speed to the desired output speed. The speed reduction obtained in the reduction box can be predetermined by choosing the appropriate size relationship between the input gear and the output gear. To increase the RPM of the equipment on the truck bed the adjustment gear box will have a larger input gear and a smaller output gear.

While the equipment on the truck bed is preferably a vertical mixer, other equipment can be installed on the truck bed to be driven by the drive mechanism.

1. A drive mechanism and a rear engine power takeoff of an engine of a truck, in combination, said truck having a cab and a truck bed extending to a rear of said cab, said rear engine power takeoff extending toward said truck bed and rotating when said engine operates, said combination comprising said drive mechanism and said power takeoff, said drive mechanism having a first shaft rotatably connected between said rear power takeoff and an activator for said drive mechanism, said activator having clutch plates and having an engaged position and a disengaged position, said activator being rotatably connected to an adjustment gearbox, said adjustment gearbox being connected to a second shaft, said second shaft being rotatably connected directly or indirectly to equipment supported on said truck bed, said drive mechanism driving said equipment when said activator is in said engaged position through rotation of said second shaft, said adjustment gearbox adjusting an RPM of said second shaft relative to said first shaft, said activator being movable between said engaged position and said disengaged position while said engine is operation.

2. A combination as claimed in claim 1 wherein said activator is a clutch.

3. A combination as claimed in claim 2 wherein said adjustment gearbox is a reduction box to reduce an RPM of said second shaft relative to said first shaft.

4. A combination as claimed in claim 3 wherein there is a third shaft rotatably connected between said clutch and said reduction box.

5. A combination as claimed in claim 4 wherein said equipment is a vertical mixer containing at least one rotatable auger, said second shaft being connected directly or indirectly to drive said auger.

6. A combination as claimed in claim 2 wherein said clutch is a torque converter.

7. A combination as claimed in any one of claims 1, 2 or 5 wherein said clutch plates are selected from the group of dry clutch plates and wet clutch plates.

8. A combination is claimed in claim 5 wherein said vertical mixer has at least one rotatable auger and, said second shaft is connected directly or indirectly to drive said augers.

9. A combination as claimed in claim 5 wherein said vertical mixer has at least two vertical augers and said second shaft is connected directly or indirectly to drive said augers.

10. A drive mechanism for use with a rear engine power takeoff of an engine of a truck, said truck having a cab and a truck bed extending to a rear of said cab, said rear engine power takeoff extending toward said truck bed and rotating when said engine operates, said drive mechanism comprising a first shaft rotatably connected between said rear power takeoff and an activator for said drive mechanism, said activator having clutch plates and having an engaged position and a disengaged position, said activator being connected to an adjustment gearbox, said adjustment gearbox being connected to a second shaft, said second shaft being connected directly or indirectly to equipment supported on said truck bed, said drive mechanism driving said equipment when said activator is in said engaged position through rotation of said second shaft, said adjustment gearbox adjusting an RPM of said second shaft relative to said first shaft, said activator being movable between said engaged position and said disengaged position while said engine is operating.

11. A drive mechanism is claimed in claim 10 wherein said activator is a clutch.

12. A drive mechanism is claimed in claim 11 wherein said adjustment gearbox is a reduction box to reduce an RPM of said second shaft relative to said first shaft.

13. A drive mechanism as claimed in claim 11 wherein there is a third shaft rotatably connected between said clutch and said reduction box.

14. A drive mechanism as claimed in any one of claims 10, 11 or 12 wherein said clutch plates are selected from the group of dry clutch plates or wet clutch plates.

15. A drive mechanism as claimed in claim 13 wherein said equipment is a vertical mixer containing at least one rotatable auger, said second shaft being connected directly or indirectly to drive said auger.

16. A drive mechanism for use with a rear engine power takeoff of an engine of a truck, said truck having a cab and a truck bed extending to a rear of said cab, said rear engine power takeoff extending toward said truck bed and rotating when said engine operates, said drive mechanism comprising an activator and an adjustment gearbox, said activator having clutch plates said activator and said adjustment gearbox being interconnected and being connected between said rear engine power takeoff and equipment supported on said truck bed, said activator having an engaged position and a disengaged position, said activator being movable between said engaged position and said disengaged position while said engine is operating.

17. A drive mechanism as claimed in claim 16 wherein said activator and said adjustment gearbox are connected between said rear engine power takeoff and said equipment supported on said truck bed by rotatable shafts.

18. A drive mechanism and a rear engine power takeoff of an engine of a truck, in combination, said truck having a cab and a truck bed extending to a rear of said cab, said rear engine power takeoff extending towards said truck bed and rotating when said engine operates, said combination comprising an activator and an adjustment gearbox, said activator having clutch plates, said activator and said gearbox being interconnected and being connected between said rear engine power takeoff and equipment supported on said truck bed, said activator having an engaged position and a disengaged position, said activator being moveable between said engaged position and said disengaged position while said engine is operating.

19. A combination as claimed in claim 18 wherein said activator and said adjustment gearbox are connected between said rear engine power takeoff and said equipment supported on said truck bed by rotatable shafts.

20. A method of constructing a mechanical drive mechanism on a rear engine power takeoff of an engine of a truck, said truck having a cab and a truck bed extending to a rear of said cab; said rear engine power takeoff extending toward said truck bed and rotating when said engine operates, said drive mechanism having a first shaft, an activator having clutch plates, an adjustment box and a second shaft, said method comprising rotatably connecting said first shaft between said power takeoff and said activator, connecting said activator to said adjustment gearbox, connecting said adjustment box to a rotatable second shaft, said second shaft being rotatably connected directly or indirectly to equipment supported on said truck bed, said activator having an engaged position and a disengaged position, starting an engine of said truck with said activator in a disengaged position, operating said engine at an appropriate RPM, moving said activator from said disengaged position to said engaged position, thereby driving said equipment on said truck bed, subsequently moving said activator from said engaged position to said disengaged position to stop driving said equipment and turning off said engine.

21. A method of constructing a mechanical drive mechanism on a rear engine power takeoff of a truck, said truck having a cab and a truck bed extending to a rear of said cab, said rear engine power takeoff extending toward said truck bed and rotating when said engine operates, said drive mechanism having an activator and an adjustment gearbox, said activator having clutch plates, said method comprising interconnecting said activator and said adjustment gearbox, connecting said activator to said rear engine power takeoff and connecting said adjustment gearbox to equipment on said truck bed.

22. A drive mechanism for use with an engine in combination with a rear engine power takeoff operatively connected to the engine before a transmission, the drive mechanism having:
a first shaft rotatably connected between said rear engine power takeoff and an activator for the drive mechanism;
an adjustment gearbox operatively connected to the activator, the adjustment gearbox being rotatably connected to a second shaft extending to at least one driven gearbox;
said second shaft being adapted for rotation up to a predetermined speed;
said activator being adapted to activate said adjustment gearbox, thereby operatively connecting said first shaft to said adjustment gearbox, and to de-activate said adjustment gearbox, thereby operatively disconnecting said adjustment gearbox from said first shaft;
said at least one driven gearbox being adapted to engage with at least one mixer upon activation of said adjustment gearbox; and
said adjustment gearbox being adapted for adjustment of the speed of rotation of said first shaft such that the speed of rotation of said second shaft is within the predetermined speed.
